(19) United States
(12) Patent Application Publication
(10) Pub. No.: US 2024/0246133 A1
(43) Pub. Date: Jul. 25, 2024

(54) METAL-SHEET STRAIGHTENING DEVICE

(71) Applicant: GYS SAS, Saint-Berthevin (FR)

(72) Inventors: Bruno BOUYGUES, Paris (FR); Sébastien COIGNARD, Changé (FR)

(21) Appl. No.: 18/420,819

(22) Filed: Jan. 24, 2024

(30) Foreign Application Priority Data
Jan. 25, 2023 (FR) 2300682

(51) Int. Cl. B21D 1/14

(52) U.S. Cl. CPC B21D 1/14

(57) ABSTRACT

The disclosure relates to a drawing device (1) intended to carry at least one drawing tool adapted to straighten metal sheets, said device (1) comprising:
a deck (10), adapted to be removably secured to a support surface (3),
a drawing column (2) configured to carry said drawing tool, said drawing column being secured to a first surface (11), referred to as the top surface, of said deck (10),
elastic sealing means (4) extending over the periphery of a second surface (12), referred to as the bottom surface, of said deck (10), said elastic sealing means (4) being configured, during the use of said device (1), to be disposed between the deck (10) and the support surface (3) to form a closed space (5), and
vacuum-generation means, in fluid communication with the closed space (5) at an orifice (13) in said deck (10), controlled and configured to generate a negative pressure in said closed space (5) so as to secure said deck (10) to said support surface (3),

According to the present disclosure, said deck (10) further comprises, on its second surface (12), at least one bearing zone (6) putting said deck (10) in contact with said support surface (3).

### FIELD OF THE DISCLOSURE

The field of the disclosure is that of automobile bodywork repair and more particularly devices intended to straighten and reshape vehicle bodywork that has been deformed following an impact or an accident for example.

More particularly again, the disclosure relates to drawing devices or traction devices.

### PRIOR ART

Manual straightening devices are known, allowing repair of automobile bodywork deformations and which comprise a substantially vertical upright that can be mounted pivotably on a base, or deck, in contact with the floor. This deck has a seal, for example made from rubber, that extends over the whole of the periphery of the deck so as to create a closed sealed space between the deck of the device and the floor on which it rests.

A pump, for example of the Venturi type, is connected to this closed space and sucks out air under the deck so as to create a vacuum for holding the deck in position on the floor by virtue of the pressure difference created by the pump.

According to this technique, the deck is substantially planar and the seal is glued to the periphery of the deck.

One drawback of this technique lies in the fact that the seal wears quickly and that its holding in position is not satisfactory. This is because, during drawing, forces (in particular shearing forces) take place on the seal, which leads to deformation thereof and sometimes even to detachment thereof from the deck, which is not satisfactory.

Another drawback lies in the fact that the seal must be replaced regularly in order to ensure that the drawing device can be used safely.

However, changing/replacing the seal is not easy because it is glued. This is because replacing the seal requires using tools and chemical products that are sometimes harmful to remove the residues of glue and of seal present on the deck before being able to glue a new seal onto the latter.

In addition, so that the gluing is effective, it is essential for the deck to be perfectly free from residues in order to ensure good gluing of the seal and good airtightness for the closed space located between the deck of the device and the floor on which it rests. Thus the operation of replacing a seal according to the known art is relatively difficult and time-consuming, which is also not satisfactory.

### SUMMARY OF THE DISCLOSURE

In designing the invention, the drawbacks of the prior art have been borne in mind. The invention relates more particularly to a drawing device, for example portable or mobile, intended to carry at least one drawing tool adapted to straighten metal sheets, said device comprising:
a deck adapted to be secured removably to a support surface,
a drawing column configured to carry said drawing tool, said drawing column being secured to a first surface, referred to as the top surface, of said deck,
elastic sealing means extending over the periphery of a second surface, referred to as the bottom surface, of said deck, said elastic sealing means being configured, during the use of said device, to be disposed between the deck and the support surface to form a closed space, and
vacuum-generation means, in fluid communication with the closed space at an orifice in said deck, controlled and configured to generate a negative pressure in said closed space so as to secure said deck to said support surface.

According to the present disclosure said deck further comprises, on its second surface, at least one bearing zone putting said deck in contact with said support surface.

Thus the use of such a bearing zone makes it possible to avoid the forces generated on the deck during use of the drawing device to be directly experienced by the sealing means. In this way, it is the bearing zone that absorbs these forces to protect the sealing means in order to limit wear thereon and thus increase the service life thereof.

Moreover, this approach makes it possible, during use of the drawing device, to apply traction or drawing forces to the bodywork to be repaired that are much greater than with the drawing devices of the prior art.

According to one particular aspect, said deck has a substantially quadrilateral shape and said deck comprises four bearing zones disposed substantially at the four corners of said deck.

Thus the use of four bearing zones, located at the four corners of the deck, provides optimum absorption of the forces generated during use of the device. In particular, the shearing forces are perfectly absorbed by this particular arrangement of the bearing zones. In addition, this arrangement ensures optimum stability of the deck on the support surface.

According to another particular aspect, said at least one bearing zone is in the form of a shoe manufactured from an adherent material.

Thus the holding in position of the deck on the support surface is improved and the risks of undesired movements of the deck with respect to the support surface during use of the drawing device are limited, or even eliminated.

According to yet another particular aspect, said at least one bearing zone is manufactured from rubber, from elastomer, from polymer or from thermoplastic.

Such materials are simple to use and inexpensive while ensuring optimum adherence and absorption of forces. The service life of shoes manufactured from such materials is furthermore relatively high and adapted to such use.

According to another particular aspect, said at least one bearing zone is secured removably to said second surface of said deck.

It is thus possible to quickly and easily replace the bearing zones, for example in the case of advanced wear or accidental damage to these means.

According to another particular aspect, said at least one bearing zone is secured by screwing. Such a securing solution is simple and quick to implement.

According to one particular aspect, said deck comprises at least one groove for receiving said elastic sealing means.

According to another particular aspect, said elastic sealing means are removably secured in said at least one groove.

Removable here refers to the fact that the sealing means can be withdrawn from the groove without degrading them, which is not the case with the solution of the prior art, which consists in removing the glued seal by any means, using tools and/or chemical products.

By virtue of the use of this groove, the sealing means can for example be forcibly secured, by interlocking or embedding in the groove. It is thus possible to quickly and easily replace the elastic sealing means, for example in the case of advanced wear or accidental damage to these means. In addition, this groove allows replacement of the elastic sealing means not requiring any tool or chemical product. Use of this groove furthermore ensures optimum and reliable positioning of the elastic sealing means under the deck to ensure optimum operation of the device.

According to one particular aspect, said elastic sealing means are in the form of a seal extending over the whole of the periphery of said second surface of said deck. Such a seal is inexpensive and simple to use.

According to another particular aspect, said seal is manufactured from polymer, and more precisely from ethylene propylene diene monomer (“EPDM”).

Such a material is inexpensive and ensures optimum airtightness of the closed space. The service life of a seal manufactured from such material is furthermore relatively high and adapted to such use.

### LIST OF THE FIGURES

The disclosure, as well as the various advantages that it has, will be more easily understood in the light of the following description of an illustrative and non-limitative embodiment thereof, and the accompanying drawings, among which:

FIG. 1 is a partial schematic view, seen from the side, of a drawing device according to the disclosure;

FIG. 2 Is a view from below of a deck of the device of FIG. 1;

FIG. 3 Is a perspective view from below of the deck of FIG. 2; and

FIG. 4 Is a view in cross section and from the side of the deck of FIG. 2.

### DETAILED DESCRIPTION

The general principle of the invention is based on the use of at least one bearing zone on the bottom surface of the deck of the drawing device so that the forces (in particular shearing forces) caused during the use of the device are applied not to the seal (or any other sealing means used) of the deck but to the bearing zone or zones.

Thus the seal is no longer stressed during the use of the drawing device.

The seal is then used solely to provide airtightness and therefore to create a negative pressure between the deck of the drawing device and the support surface (generally the floor). In this way the service life of the seal is prolonged significantly.

In addition, because the seal is no longer stressed by the forces generated during the use of the drawing device, a novel solution for securing the seal can be used.

This solution consists in providing a groove on the bottom surface of the deck and securing the seal in this groove, and all this without requiring a tool or chemical product. In this way, installing and replacing the seal is facilitated.

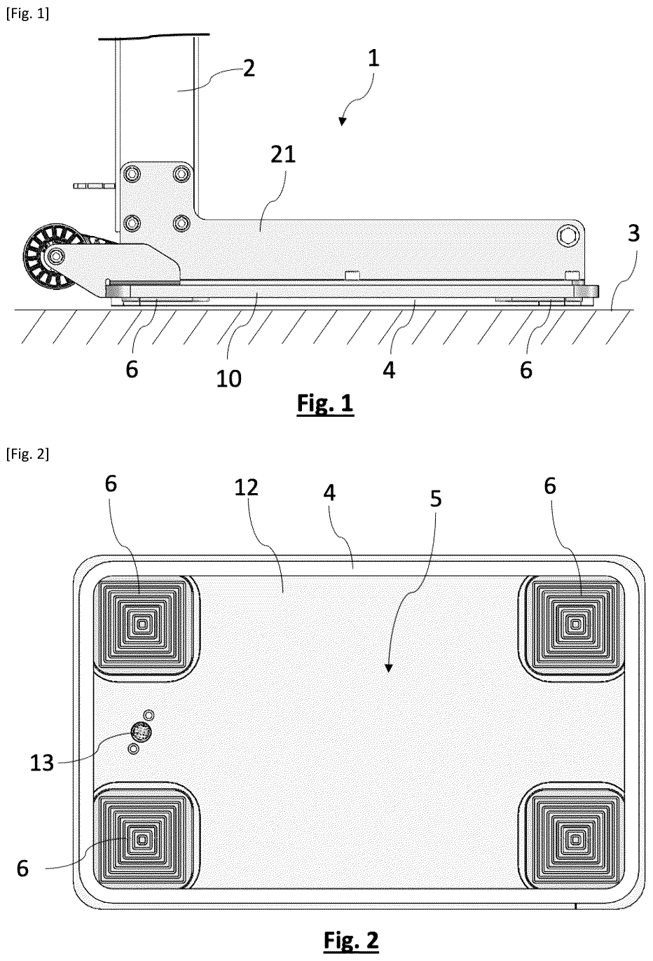

FIG. 1 partially illustrates a drawing, or traction, device 1 intended to straighten metal sheets, for example for the automobile bodywork field. Such a drawing device 1 is able to carry at least one drawing tool cooperating with one or more corresponding drawing elements secured to the metal sheet to be straightened.

As illustrated, the drawing device 1 comprises a deck 10 adapted to be secured removably to a support surface 3 (for example the floor of the workshop). The drawing device 1 furthermore comprises a drawing column 2 configured to carry the drawing tool or tools. The drawing column 2 is secured to a first surface 11, referred to as the top surface, of the deck 10. In the example illustrated, the drawing column 2 is secured to the deck 10 via a support element 21 having a substantially L-shape, but other solutions can be envisaged. The drawing column 2 and the deck 10 can be secured to the support element 21 for example by screwing or any other solution making it possible to obtain a reliable attachment of the elements to each other.

The drawing device 1 can be portable, on mobile, so as to be able to be moved in a workshop, for example.

In all cases, the deck 10 can be secured to the support surface 3 by suction, i.e. by creating a negative pressure, or in other words a vacuum, between the deck 10 and the support surface 3.

In this regard, and as illustrated on FIG. 2, the deck 10 comprises elastic sealing means 4 extending over the periphery of a second surface 12, referred to as the bottom surface, of the deck 10.

In this example, the elastic sealing means 4 are in the form of a seal. This seal 4 is configured, during use of the drawing device 1, to be disposed between the deck 10 and the support surface 3 to form a sealed closed space 5.

Means for generating a vacuum (not illustrated) are connected in fluid communication with the closed space 5 at an orifice 13 provided in the deck 10.

These means for generating a vacuum, for example in the form of an air pump, can be controlled so as to generate a negative pressure in the closed space 5. Thus the control of the means for generating a vacuum enable the user to secure the deck 10 to the support surface 3 during use of the drawing device 1 and to release the deck 10 from the support surface 3 when the drawing device 1 must be moved, for example.

Advantageously, the bottom surface 12 of the deck 10 comprises at least one bearing zone 6 disposed in the closed space 5, i.e. in the space delimited by the seal 4. Such a bearing zone 6 is configured to come into contact with the support surface 3 so as to absorb the forces, in particular shearing forces, that are generated when the drawing device 1 is in use.

In this way, the seal 4 is no longer subjected to any mechanical force and the sole role thereof is to seal the closed space 5.

Thus the seal 4 is protected from any premature deterioration, which increases its ability to maintain the vacuum and its service life. The use of bearing zones 6 furthermore enables a greater traction force to be applied than in the solutions of the prior art since it is no longer the seal 4 that is subjected to these forces.

This is because the bearing zone or zones are configured to absorb much greater forces than a flexible seal 4.

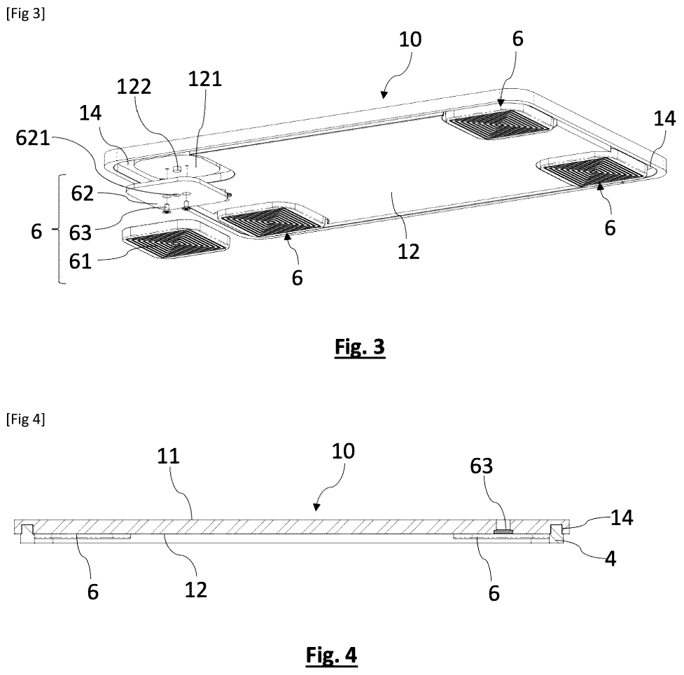

Preferably, and as illustrated on FIGS. 2 and 3, the deck 10 has a substantially rectangular shape. Bearing zones 6 are disposed at the four corners of the deck 10. Thus the drawing device 1 comprises four bearing zones 6 that optimally absorb the forces to which the deck 10 is subjected during use of the drawing device 1. In addition, using four bearing zones 6 disposed in this way ensures optimum equilibrium and stability of the drawing device 1.

In variants that are not illustrated, it could be envisaged using more or fewer bearing zones 6 under the deck 10, without departing from the general principle of the invention.

Nevertheless, using four bearing zones 6 makes it possible to obtain an optimum compromise between absorption of the forces and suction force to ensure effective holding in position of the drawing device 1 during use thereof.

In the example illustrated, the bearing zones 6 are in the form of flexible shoes, preferably manufactured from flexible rubber.

These shoes 6 have a substantially square or rectangular shape and have high adherence ensuring the holding in position of the drawing device 1 on the support surface 3. The form of the shoes 6 is preferably selected to correspond to the form of the deck and/or to the path of the seal 4 under the deck 10.

Thus, in this example, the angles or corners of the shoes are rounded to correspond to the path of the seal 4.

It should be noted that, as illustrated on FIG. 2, the shoes 6 and the seal 4 are disposed so as to be close together, in particular at the angles or corners of the deck 10, in order to provide optimum airtightness of the closed space 5. This arrangement also ensures that it is indeed the shoes 6 that absorb the forces during use of the drawing device 1.

The shoes 6 must have dimensions sufficient to ensure optimum absorption of the forces during use of the device 1. These dimensions are also selected according to those of the deck 10 and/or the closed space 5 in order to ensure optimum securing of the deck to the support surface 3.

As illustrated on FIG. 3, the shoes 6 are, in this example, removable so as to allow easy withdrawal and/or replacement thereof, for example in the case of wear.

In this example, each shoe 6 comprises a cushion 61 cooperating with a support base 62 intended to be secured to the bottom surface 12 of the deck 10. More precisely, the deck 10 comprises recesses, or pockets, 121 for receiving the shoes 6.

In this example, the support bases 62 are secured to the deck 10 by securing screws 63.

It will be understood that other removable securing solutions can be envisaged without departing from the principle of the invention.

It should be noted that, on the example in FIG. 3, the reception pocket 121 also has a centring pin 122 cooperating with a corresponding centring aperture 621 provided in the support base 62.

The deck 10 of the drawing device 1 preferably comprises at least one groove 14 for receiving sealing means 4.

In the example illustrated on FIGS. 2 to 4, the deck 10 comprises a single groove 14 extending over the whole of the periphery of the bottom surface 12 of the deck 10.

This groove 14 is configured to receive and hold the seal 4.

To do this, the groove 14 has in this example a substantially square or rectangular cross-section, as illustrated in detail on the cross-sectional view in FIG. 4. The seal 4 has a cross-section with a corresponding shape.

The seal 4 preferably has dimensions greater than the groove 14 so that it can be interlocked or force-fitted in the groove 14.

Thus no tool or chemical product is necessary to install the seal 4 in the groove 4 and/or to remove it.

More precisely, the seal 4 has flexibility or elasticity that enables it to be compressed when it is installed in the groove 14. Next its natural expansion ensures optimum holding of the seal 4 in the groove 14. Removing the seal 4 does however remain simple since it does not require any tool or chemical product.

The groove 14 therefore makes it possible to no longer have to glue the seal 4 to the deck 10, unlike the solutions of the prior art.

This solution of securing the seal 4 in the groove 14 is also made possible because of the use of the bearing zones 6 that absorb the forces during the use of the drawing device 1, instead of it being the seal 4 that has to absorb these forces.

Obviously it is clearly understood that the thickness of the seal 4, the thickness of the shoes 6 and the depth of the reception pockets 121 are selected so that the shoes 6 are in contact with the support surface 3 when the vacuum is produced in the closed space 5 so that it is the shoes 6 that absorb the shearing forces rather than the seal 4.

It is also understood that the form of the shoe 10 may be different from the rectangular form illustrated in this example.

The deck 10 can have any other form and the bearing zones 6 can be disposed differently as long as the advantages previously targeted in relation to these elements are kept.

For example, the deck 10 can have a quadrilateral shape and have a bearing zone at each corner/angle.

The deck 10 is preferably manufactured from metal in order to provide sufficient resistance to the forces experienced during the use of the drawing device 1.

In particular, the deck can be manufactured from steel in order to limit the manufacturing costs. The deck 10 is preferably manufactured from aluminium, for example from aluminium 5083 or from aluminium 2017, in order to limit the weight of the device 1 and therefore facilitate movement thereof.

In addition, the use of aluminium facilitates the machining of the orifice 13 and of the pockets 121 receiving the shoes 6, in particular.

The deck 10 has, for example, a length of approximately 60 cm and a width of approximately 40 cm. The surface area of the closed space 5 located under the deck 10 between the seal 4 is for example approximately 0.181 m².

It will obviously be understood that other dimensions can be envisaged, in particular according to requirements and the drawing forces to be exerted, without departing from the general principle described above.

The seal 4 is preferably manufactured from polymer, and more precisely from ethylene propylene diene monomer (“EPDM”).

Other materials making it possible to ensure optimum airtightness of the closed space 5 while allowing installation and removal of the seal 4 in and from the growth 14 without a tool can be envisaged without departing from the principle of the invention.

For example, the seal 4 has a thickness of between approximately 1 and 2 cm, and preferably 1.5 cm. Its weight can for example be between 1.5 and 2.5 cm, and preferably 2 cm. Other dimensions can be envisaged, in particular according to the dimensions of the deck for example, without departing from the general principle described above.

The example illustrated presents a groove 14 having a square or rectangular shape. It will be understood that other shapes can be envisaged as long as they enable the seal 4 to be installed and removed in and from the groove 14 without a tool.

The seal 4 can also have any form enabling it to provide the aforementioned advantages.

The shoes 6 are preferably manufactured from rubber in order to provide optimum adherence and absorption of the forces, in particular shearling forces.

Other materials, such as thermoplastics and elastomers, can be envisaged without departing from the principle of the invention.

Preferably again, the shoes 6 are manufactured from TPE or from TPR 65 Shore A. They can for example have a substantially square shape of 10 cm by 10 cm.

Other dimensions and shapes can be envisaged without departing from the general principle described above.

1. Drawing device intended to carry at least one drawing tool adapted to straighten metal sheets, said device comprising:
a deck, adapted to be removably secured to a support surface,
a drawing column configured to carry said drawing tool, said drawing column being secured to a first surface, referred to as the top surface, of said deck,
elastic sealing means extending over the periphery of a second surface, referred to as the bottom surface, of said deck, said elastic sealing means being configured, during the use of said device, to be disposed between the deck and the support surface to form a closed space, and
vacuum-generation means, in fluid communication with the closed space at an orifice in said deck, controlled and configured to generate a negative pressure in said closed space so as to secure said deck to said support surface,
characterised in that said deck further comprises, on its second surface, at least one bearing zone putting said deck in contact with said support surface.

2. Drawing device according to claim 1, characterised in that said deck has a shape substantially in a quadrilateral and in that said deck comprises four bearing zones disposed substantially at the four corners of said deck.

3. Drawing device according to claim 1, characterised in that said at least one bearing zone is in the form of a shoe manufactured from an adherent material.

4. Drawing device according to claim 3, characterised in that said at least one bearing zone is manufactured from rubber, from elastomer, from polymer or from thermoplastic.

5. Drawing device according to claim 1, characterised in that said at least one bearing zone is secured removably to said second surface of said deck.

6. Drawing device according to claim 5, characterised in that said at least one bearing zone is secured by screwing.

7. Drawing device according to claim 1, characterised in that said deck comprises at least one groove for receiving said elastic sealing means.

8. Drawing device according to claim 7, characterised in that said elastic sealing means are removably secured in said at least one groove.

9. Drawing device according to claim 1, characterised in that said elastic sealing means are in the form of a seal extending over the whole of the periphery of said second surface of said deck.

10. Drawing device according to claim 9, characterised in that said seal is manufactured from polymer, and more precisely from ethylene propylene diene monomer.
